(19) United States
(12) Patent Application Publication
(10) Pub. No.: US 2009/0188885 A1
(43) Pub. Date: Jul. 30, 2009

(54) REPLACEABLE BOTTLE CAP ASSEMBLY

(76) Inventor: Patrick Myron Nichols, Malone, NY (US)

Correspondence Address: Hiscock & Barclay, LLP, One Park Place, 300 South State Street, Syracuse, NY, 13202-2078, US

(21) Appl. No.: 12/360,561

(22) Filed: Jan. 27, 2009

Related U.S. Application Data
(60) Provisional application No. 61/131,575, filed on Jun. 10, 2008.
(60) Provisional application No. 61/062,804, filed on Jan. 28, 2008.

(51) Int. Cl. B65D 45/32; B23P 11/00

(52) U.S. Cl. 215/272; 29/428

(57) ABSTRACT

A replaceable bottle cap assembly includes a body that conforms to the top of a threaded beverage container, the assembly including an internally threaded portion that mates with the threaded neck of the beverage container. A hinged cap of the assembly provides selective access to the contents of the attached bottle wherein the assembly is sealingly and releasably attached to the container.

### CROSS-REFERENCE TO RELATED APPLICATIONS

This patent application claims priority as to the following provisional patent applications entitled: REPLACEABLE BOTTLE CAP ASSEMBLY, U.S. Ser. No. 61/131,575, filed Jun. 10, 2008, and BEVERAGE BOTTLE REPLACEMENT CAP WITH HANDLE, DRINKING AND HOLDING DEVICE, U.S. Ser. No. 61/062,804, filed on Jan. 28, 2008, the entire contents of each being herein incorporated by reference.

### FIELD OF THE INVENTION

The invention relates to the field of beverage containers and in particular to a replaceable bottle cap assembly that can be used in conjunction with threaded beverage containers, such as water and soda bottles.

### BACKGROUND OF THE INVENTION

Beverage containers, including those for bottled soda, bottled water, energy drinks and fruit juices, among others, have been commonly known to consumers for many years. Most of these containers include a threaded cap at the top or neck of a 12 ounce, 24 ounce or other appropriately sized bottle. In order to access the contents of the bottle for consumption, the threaded cap must first be twisted free and then removed. Typically, the entire contents of the bottle are not consumed all at once. Therefore, it later becomes necessary to reattach the cap to the bottle by twisting the cap back onto the threaded neck of the bottle in order to avoid spillage of the remaining fluid contents and avoid having the contents go flat as in the case of carbonated fluids, such as soda.

The foregoing arrangement is not always convenient. This two-hand requirement is exacerbated given that one hand of the consumer is required to hold the bottle for stability while the other hand is being used to actually twist open or replace the cap. When the consumer is traveling by vehicle (e.g., car, truck or boat), is operating equipment, or is otherwise conducting activities wherein the removal of a twist-off cap would be hazardous. Another relevant issue is that of having to locate or re-locate the cap once it has been removed from the bottle. In each instance, the consumer's attention is otherwise directed from the immediate task at hand and potential safety concerns are therefore created for the consumer and others. Therefore, it is a general desire in the field to provide an alternate, safer and more convenient means for accessing and extracting the fluid contents from threaded beverage containers.

### SUMMARY OF THE INVENTION

According to one aspect, there is provided a replaceable bottle cap assembly, the assembly including a body shaped to substantially conform with the top of a beverage container, the body having a threaded portion that enables connection to a threaded bottle neck. A cap is hingably attached to the body, the cap being releasably attached and configured relative to the body in order to selectively access the contents of a bottle to which the cap is attached. The body can be made from a soft, durable and lightweight elastomeric material, wherein, for example, the body can be fabricated using a blow-molding process, at least in part, and in which the assembly is reusable and washable. According to at least one version, at least a portion of the body is formed from a soft, grippable elastomeric material to facilitate handling of the assembly.

In one version, the cap is tethered to the body or the cap can be integrally formed therewith. According to one embodiment, the cap is secured or otherwise attachable to the body for storage when the cap is in an open position. According to one embodiment, the body includes a retaining member enabling the cap to be releasably secured thereto while in the open position. The cap is snap-fitted to a spout, the spout extending to the interior of the bottle wherein an effective fluidic seal in combination with the threading action of the body to the bottle is achieved, when the cap is in the closed position.

The body of the replaceable cap assembly can be defined with an integral threaded section. Alternatively, other threaded sections can be employed and/or a separate adapter can be implemented, enabling attachment of the herein described cap assembly to a plurality of different types of bottles that have varying thread designs.

The replaceable cap assembly further includes a handle portion that is integral or otherwise attached to the body enabling both the assembly and attached bottle to be conveniently lifted by the user. A skirting portion provided on the body provides a counter balance for the handle portion and cap, such as when the bottle is nearly empty or empty.

According to another version, there is described a method for manufacturing a replaceable cap assembly for use with at least one bottle, said bottle including a threaded neck, said method comprising the steps of providing a body having a threaded portion that can releasably attached to the threaded neck of said bottle, and providing a releasable cap that can be selectively opened, thereby enabling the contents of a beverage container to be accessed for consumption.

In one version, the cap is hinged to the body. In another version, the cap can be integrally formed with the body.

According to yet another version, the body can include an integral threaded portion or alternatively the body can be defined by a first thread wherein at least one thread adapter can be added enabling the assembly to be attached to beverage containers having different thread designs. For example and according to one embodiment, a separate adapter is attached to the body and includes a thread that enables attachment to other beverage containers. In another embodiment, a separate adapter can include multiple threads; for example, an upper portion with a first thread and a lower portion with a second thread, each of the upper and lower portions being releasably attachable to said body.

One advantage provided by the herein described replaceable cap assembly is ease of use as opposed to the twist off cap of conventional threaded beverage bottles that require removal for each use. There is no longer a need to retain the original bottle cap and therefore having to be concerned about its whereabouts. The assembly provides an effective fluidic seal and therefore maintains all of the functionality provided by twist-off caps, but with considerably less effort. Another advantage is that the herein described assembly can be cleaned and is reusable. Yet another advantage is that the herein described cap assembly can be adaptively attached to any sized beverage container and to any thread design.

These and other features and advantages will be readily apparent from the following Detailed Description, which should be read in conjunction with the accompanying drawings.

### BRIEF DESCRIPTION OF THE DRAWINGS

FIG. 1 is a side view of a replaceable bottle cap assembly in accordance with an exemplary embodiment of the present invention;

FIG. 2 is a front view of the replaceable bottle cap assembly of FIG. 1;

FIG. 3 is a top plan view of the replaceable bottle cap assembly of FIGS. 1 and 2;

FIG. 4 is an exploded assembly view of the replaceable bottle cap assembly in conjunction with a beverage container;

FIG. 4(a) is a side perspective view of the exploded releasable cap assembly of FIG. 4, shown in section;

FIG. 5 is a bottom perspective view of the replaceable bottle cap assembly of FIGS. 1-3 with the cap in the closed position;

FIG. 6 is a bottom perspective view of the replaceable bottle cap assembly, shown as exploded;

FIG. 7 is a side elevational view of the replaceable bottle cap assembly of FIGS. 1-6 as attached to a beverage container, the view being taken in section and in which the cap is shown in a closed position;

FIG. 8 is the side elevational view of FIG. 7 taken in section, wherein the cap is shown in an opened position;

FIG. 9 is a front view taken in elevation of the replaceable bottle cap assembly as attached to a beverage container;

FIG. 10 is a side view taken in elevation of the replaceable bottle cap assembly as attached to a beverage container;

FIG. 11 is a top plan view of the assembly of FIGS. 9 and 10;

FIG. 12 is a front perspective view of the assembly of FIGS. 9-11;

FIG. 13 is the front perspective view of the assembly of FIGS. 9-11 with the cap in the opened position; and

FIGS. 14(a)-14(c) depict perspective views of variations of the replaceable bottle cap assembly of FIG. 1-6 in an assembled condition relative to a beverage container.

### DETAILED DESCRIPTION

The following description relates to preferred embodiments of a replaceable bottle cap assembly, shown independently as well as in conjunction with a threaded beverage container (e.g., a 16-20 ounce soda, water or other beverage bottle). Throughout the course of discussion, certain terms are used in order to provide a suitable frame of reference with the accompanying drawings such as “top”, “front, “rear”, “bottom”, “upper”, “lower”, “inner”, “outer”, “above”, below”, and the like. These terms are not intended to be overly limiting, however, except where so specifically limited. Moreover, it will be appreciated that variations and modifications are possible within the intended scope of the present invention and that the herein described bottle cap assembly and beverage container are intended to be merely exemplary.

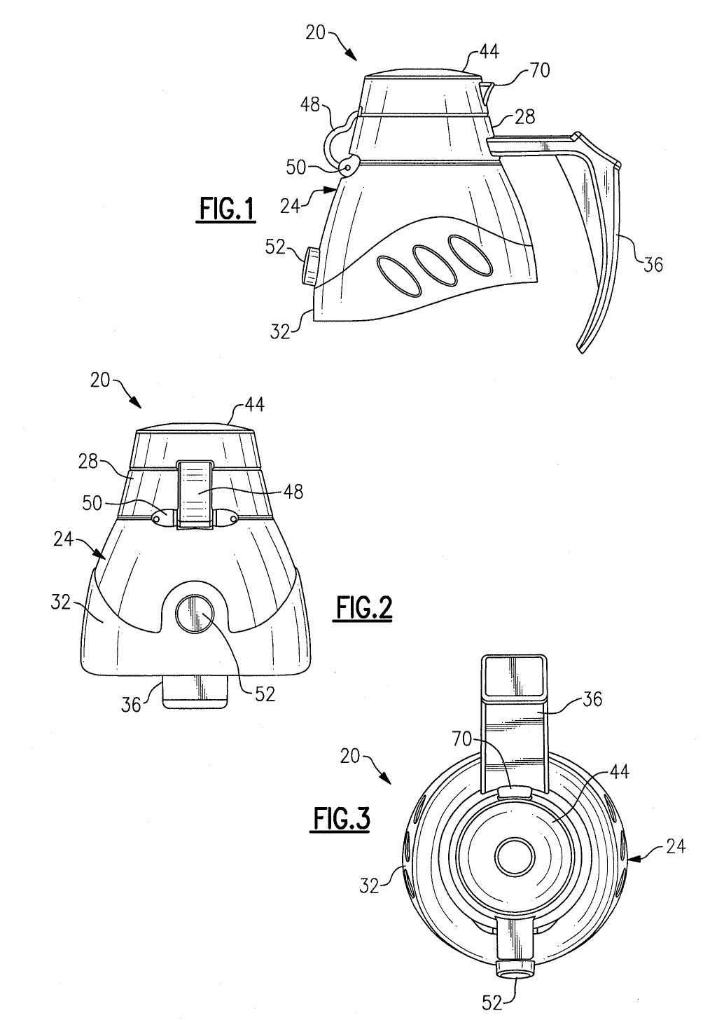

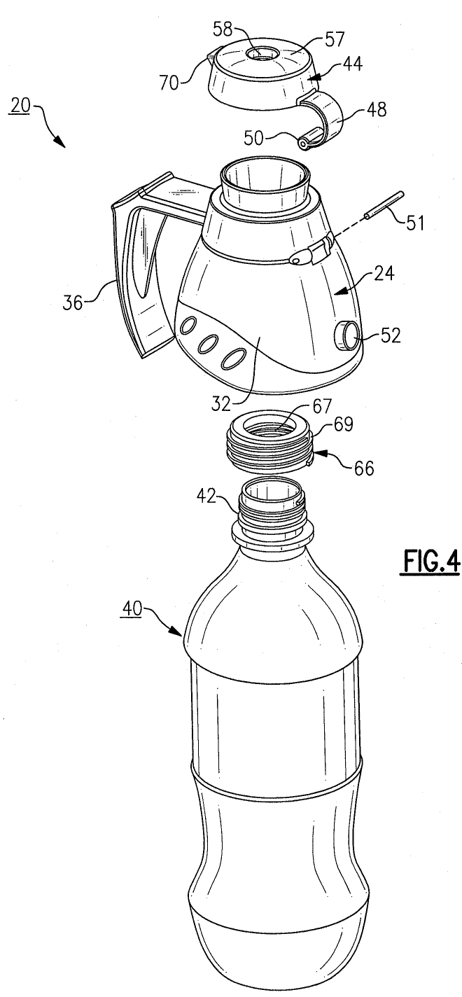

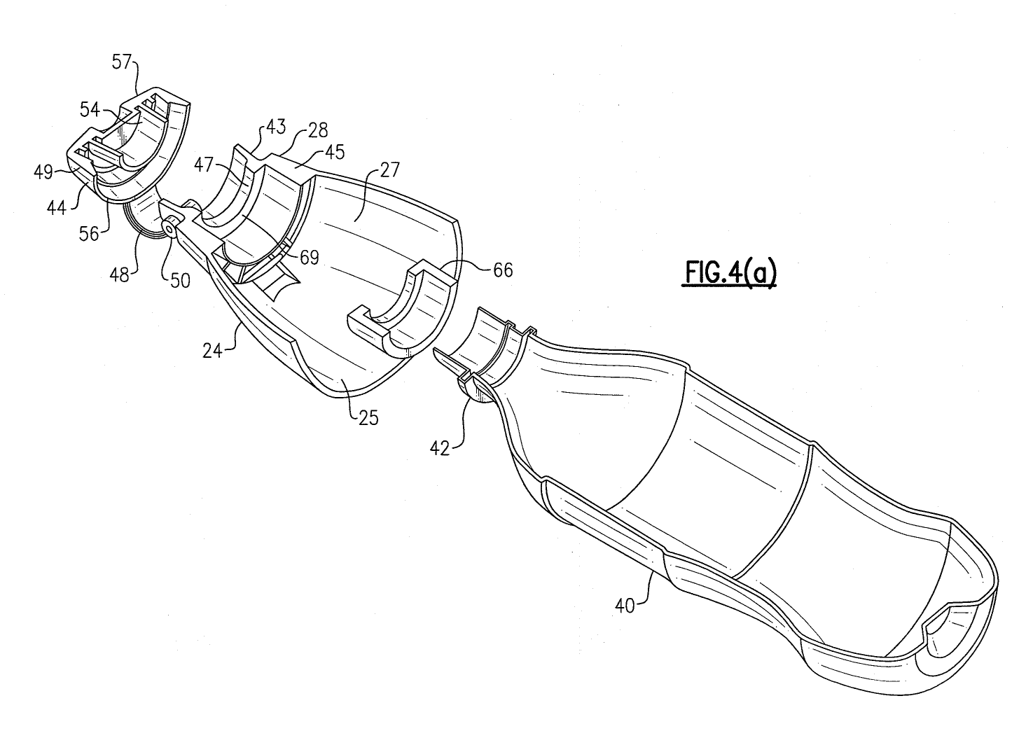

Referring to the figures and more specifically to FIGS. 1-3, there is shown a replaceable bottle cap assembly, herein generally labeled with reference numeral 20, which is defined by two interconnected components, namely a body 24 and a cap 44. The body 24 according to this exemplary embodiment is made from a durable, lightweight elastomeric material, and can be manufactured using, for example, a blow-molding or injection molding process. A skirting portion 32 is provided at the lower end of the body 24, which is further defined by a generally hemispherical shape, while an engagement portion 28 is provided at the upper end of the body. As shown in greater detail in FIGS. 4, 4(a), and FIGS. 5-8, the body 24 is substantially hollow, with the exception of the engagement portion 28, including an open lower opening 25 extending to an interior cavity 27 shaped to substantially conform with the curved top or upper end of a beverage container, herein shown as 40. Due to the conforming curvature of the body 24, the interior cavity 27 narrows in diameter away from the open lower opening 25. Referring most particularly to FIGS. 4(a), 6 and 7, the engagement portion 28 is provided above the skirting section 32, the engagement portion being defined by an upper engagement end or spout 43 that permits releasable engagement of the cap 44, described in greater detail below, and a lower engagement end 45 that enables releasable attachment of the assembly 20 with the threaded neck 42 of the bottle 40. The engagement portion 28 is further defined by a through opening 47 having a first diameter in the upper engagement end 43 and a narrower second diameter in the lower engagement end 45. An annular flange 69 divides the upper and lower engagement ends 43, 45, wherein the through opening 47 is of reduced diameter than either the upper or lower engagement ends and forms a throat therebetween. According to the present embodiment, the engagement portion 28 is integrally formed with the remainder of the body 24, such as through mold fabrication, although these components could also be separately manufactured and assembled.

Completing the description of the body 24 and referring again to FIGS. 1-3, an integral handle portion 36 is attached to the exterior of the engagement portion 28 of the body 24, the handle portion extending outwardly from a rear side of the assembly 20 according to this herein described embodiment. The handle portion 36 can be molded as part of the entire assembly or attached by conventional means to the remainder of the assembly 20.

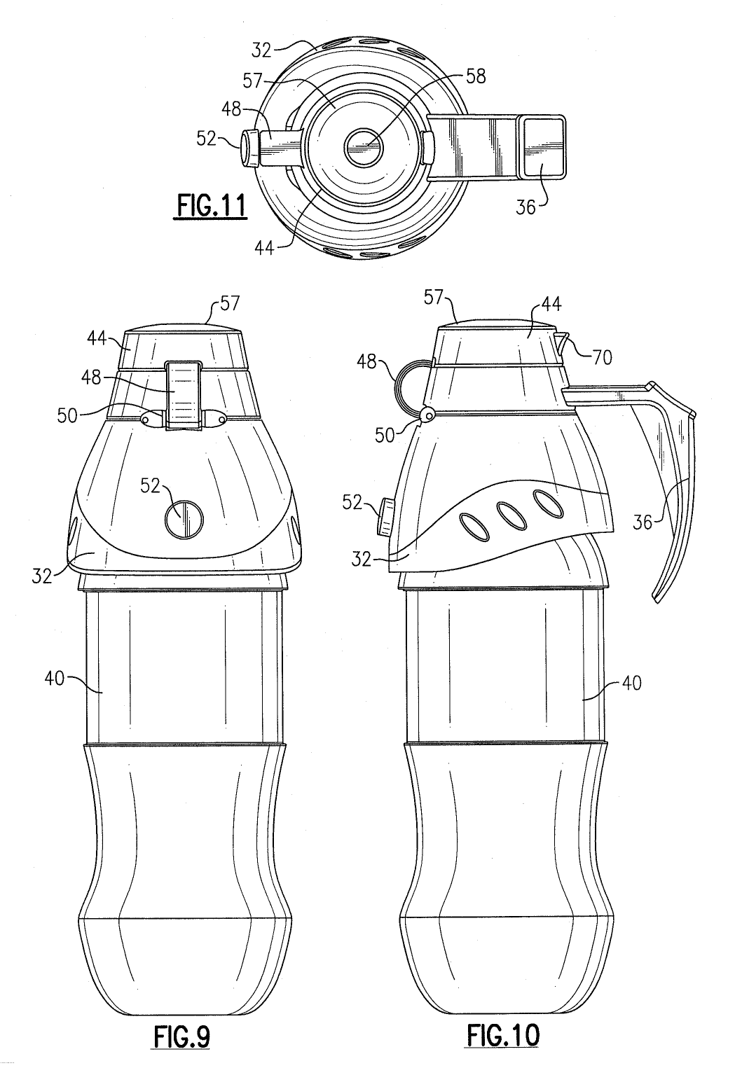

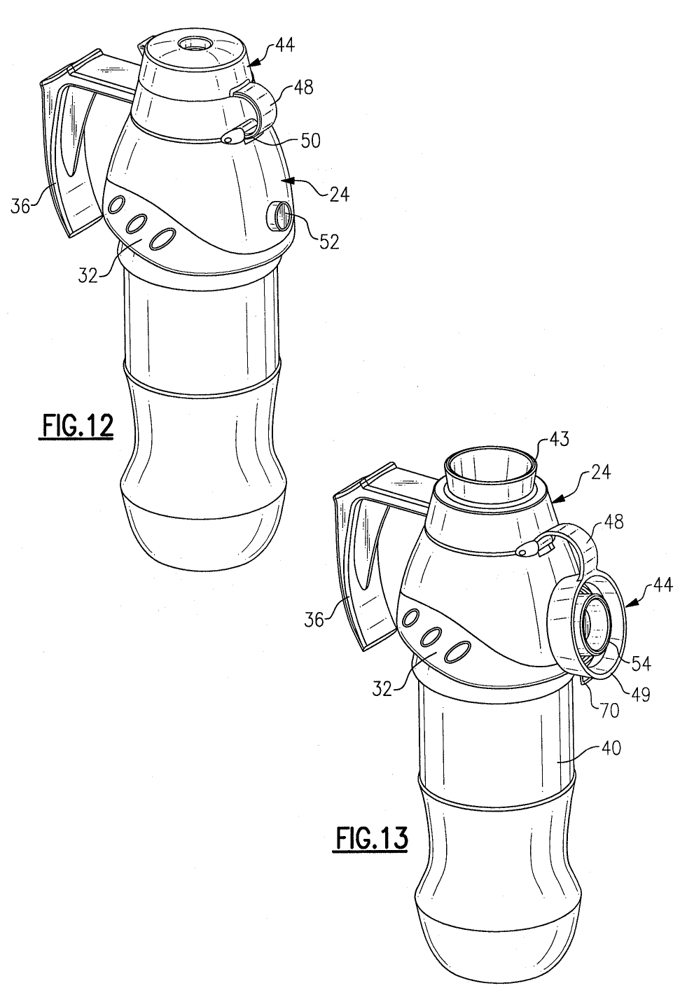

In brief and as shown in FIGS. 4-13, the cap 44 is designed to be releasably attached to the upper engagement end or spout 43 of the engagement portion 28 of the body 24. According to the present embodiment, the cap 44 is a separate component of the herein described assembly 20 and is also preferably made from a molded plastic material, although other materials could be utilized. The cap 44 is attached by means of a flexible plastic tether 48 to a hinge 50, which according to this specific embodiment includes a hinge pin 51, the hinge being connected by known means to the body 24. The cap 44 according to this exemplary embodiment is defined by a circular configuration and includes a recessed portion formed on an interior surface 56 separating an outer and an inner peripheral ring 49, 54, respectively. The outer peripheral ring 49 is preferably inwardly beveled and is locally deformable, enabling the cap to be attached in snap-fitting relation to the spout 43. The inner peripheral ring 54 is also flexible and is sized to fit within the through opening 47 defined by the annular flange 69 separating the spout 43 and lower engagement end 45.

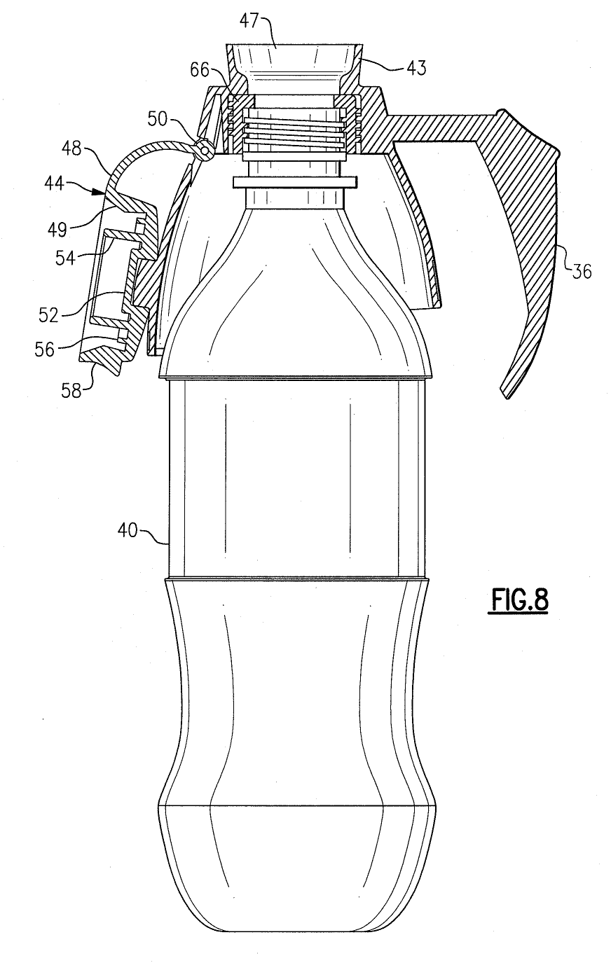

On an exterior facing surface 57 of the cap 44 at substantially the center thereof, a formed recess 58 is provided in. According to this embodiment, a plug 52 provided at the front of the body 24 upon the skirting portion 32 permits the cap 44 to be releasably secured thereto when the cap is in an open position, such as shown in FIGS. 8 and 13. Alternatively and in lieu of the plug, a recess or cavity or at least one slot or other retention means can be provided on the front of the herein described assembly 20 or can be otherwise disposed thereupon in order to enable the cap 44 to be secured in a reliable manner while in the open position. Alternatively still, it should be realized that a plug could be provided on the cap for receipt in a cavity provided on the body 24 that would permit a similar snap fitting connection and permit the cap 44 to remain stored while in the open position. As noted, other attachment means can be utilized, such as slots or other means, and that those described are intended only to be exemplary.

The interior surface of the lower engagement end 45 can be defined, according to one version, with a generic thread 46, FIG. 6, the diameter of the lower engagement end being appropriately sized to enable the assembly 20 to be threadingly engaged and disengaged with the threaded neck 42 of the beverage container 40 according to one embodiment. In accordance with another embodiment, herein shown by way of the exploded assembly views depicted in FIGS. 4, 4(a), and 6, an adapter 66 can be introduced for attachment to the engagement portion 28, whether releasably or by means of a fixed attachment using glue, heat-staking or the like. The adapter 66 is a substantially cylindrical member that includes an internal thread 67, FIGS. 4, 6, matching the thread of the neck 42 of the beverage container 40. In this instance, the interior diameter 67 of the adapter 66 must be appropriately sized to engagingly mate with the neck 42 of the bottle 40 while the interior diameter of the lower engagement end 45 must be appropriately sized to accommodate the threaded exterior surface 69 of the adapter. According to one variation, the interior surface of the lower engagement end 45 includes a thread that mates with an external thread 69 of the adapter 66, wherein the interior surface 67 of the adapter can include a different thread to enable versatility. An elastomeric O-ring (not shown) can further be included between the adapter 66 and the annular flange 69 to further provide additional leakproofing. According to yet another variation, the adapter 66 can include two different internal threads, a first thread that is provided along an axial upper interior portion and a second thread provided along a lower interior portion. As such, the adapter 66 can be releasably attached by recognizing the appropriate thread of the bottle 40 and rotating either the upper or lower portions into engagement with the threaded neck, to provide additional versatility, the adapter thereby permitting the assembly 20 to accommodate and mate with additional bottle designs.

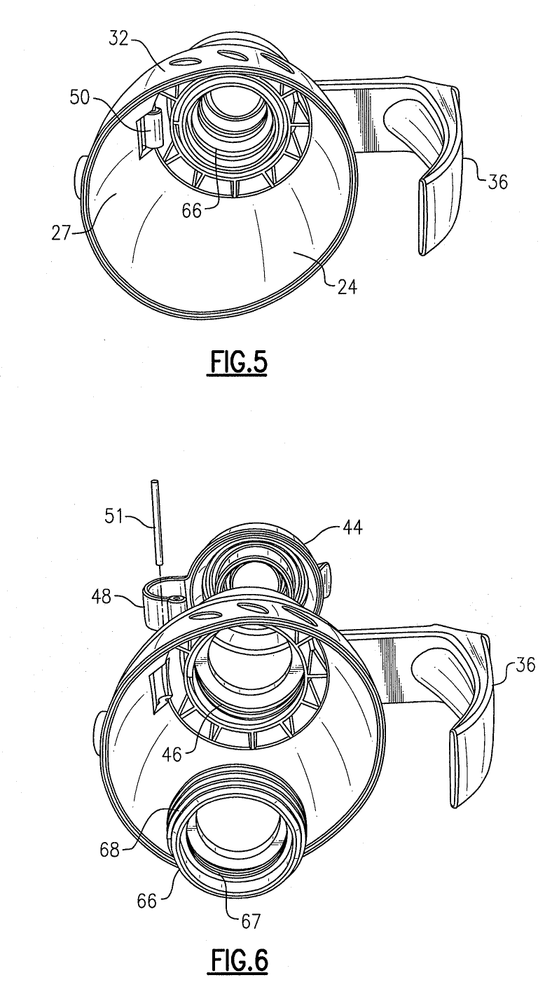

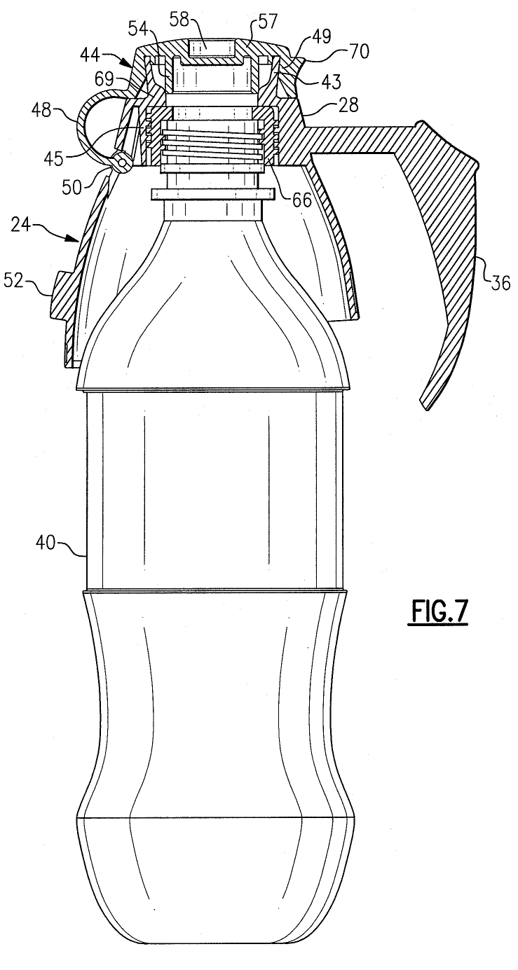

In use and referring to FIGS. 7-13, the threaded cap (not shown) of a beverage container 40 is first twisted off and discarded. The body 24 of the herein described assembly 20 is then attached to the top of the beverage container 40 after the adapter 66 has first been attached to the lower engagement portion of the assembly 20 as shown in FIG. 5, if needed, depending on the bottle. The body 24 is threaded by gripping the bottle 40 and rotating the bottle in a clockwise direction to tighten the assembly 20 in place and in which a lower surface of the annular flange 69 provides a mechanical stop against over rotation. In the assembled condition, the skirting portion 32 is placed into substantial and direct contact with the top of the bottle 40.

In the closed position, the combination of the threaded engagement portion and the cap 44 provides a sufficient and comparable fluidic seal as would be provided by the twist-off cap, if provided alone. In order to access the contents of the bottle 40 and rather then having to untwist the body 24, the cap 44 can be releasably removed from the top of the bottle 40 through its hinged connection by pushing against a front flange 70 of the cap, releasing the cap from the spout 43 of the body 24. Upon opening, the cap 44 can be stored using the plug 52 as attached to the recess 58, also in releasable snap-fitting engagement. In this position, shown in FIGS. 8 and 13, the position of the cap 44 is no longer a concern and does not interfere with the assembly 20. The fluid seal between the threaded neck 42 of the bottle 40 and the interior surfaces of the engagement portion 28 prevent spillage other than through the spout 43 through opening 69 wherein the handle portion 36 is used to lift the assembly 20 and attached beverage container 40. The bottom of the container 40 remains unaffected by way of this attachment and therefore the bottle can be stored in a receptacle (not shown) sized to ordinarily fit the bottle, such as cup or bottle holders typically found in automobiles.

Upon assembly, the skirting portion 32 besides providing an ergonomic advantage further provides a counterbalance to the handle portion 36 so as to prevent an empty or nearly depleted beverage container 40 from tipping while it remains free standing.

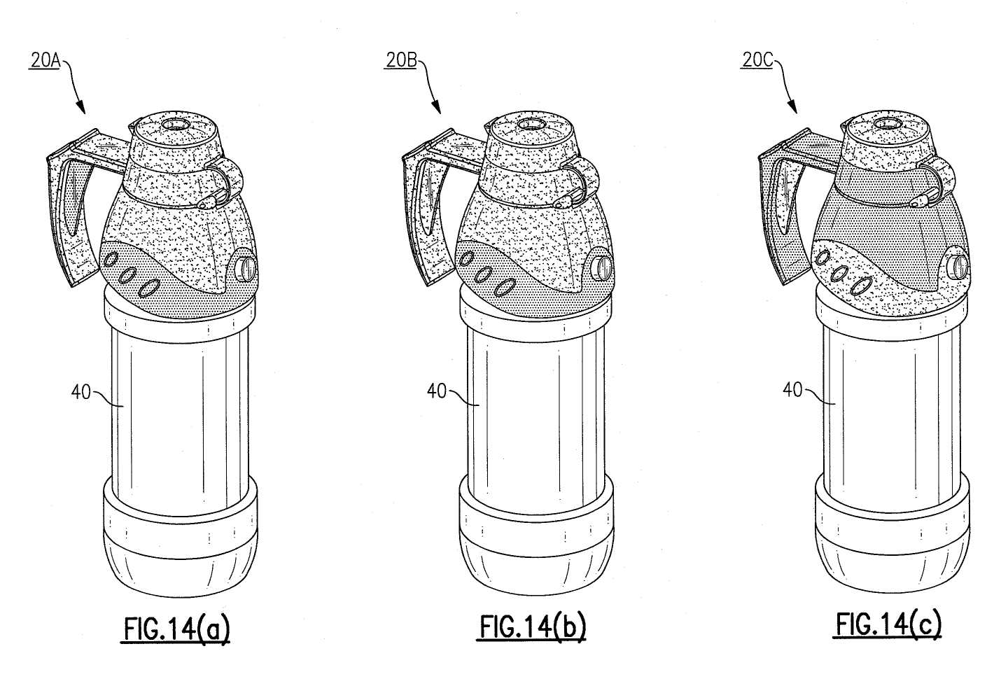

Referring to FIGS. 14(a)-14(c), variations 20(a), 20(b) and 20(c) of the herein described assembly are shown in which the skirting portion and body can be suitably configured and designed for aesthetic and detailing purposes in which varied color schemes of the assembly can be employed. It should be understood that other suitable variations can easily be contemplated.

Parts List for FIGS. 1-14(c)
20 replaceable bottle cap assembly
24 body
25 open lower opening
27 interior cavity
28 engagement section
31 threaded portion
32 skirting portion
36 36 handle portion
40 beverage container (bottle)
42 threaded neck
43 upper engagement end or spout
44 cap
45 lower engagement end
46 thread, lower engagement end
47 through opening
48 tether
49 outer peripheral ring
50 hinge
51 hinge pin
52 plug
54 inner peripheral ring
56 interior surface, cap
57 exterior surface, cap
58 recess
66 adapter
67 interior thread, adapter
68 exterior thread, adapter
69 annular flange
70 front flange

It will be readily apparent that numerous variations and modifications are possible within the intended ambits of the invention as defined by the following claims.

1. A replaceable bottle cap assembly for use with a threaded beverage container, said assembly comprising:
a body shaped to substantially conform with the top of a beverage container, the body having a threaded portion that is configured to engage a threaded bottle neck; and
a snap-fitting cap attached to said body, the cap being releasably attachable relative to said threaded portion in order to selectively access the contents of a bottle to which the cap is attached.

2. The assembly as recited in claim 1, wherein said body includes a skirting portion that is shaped to conform with the curved top of said beverage container.

3. The assembly as recited in claim 1, including retaining means for retaining said cap when said cap is in an open position.

4. The assembly as recited in claim 3, wherein said retaining member includes a recess provided in one of said cap and said body for engaging a plug provided in the other of said body and said cap.

5. The assembly as recited in claim 1, including an adapter having at least one threaded portion, said adapter being interposed between said threaded portion and said neck.

6. The assembly as recited in claim 1, wherein at least a portion of said body is made from a soft grippable material.

7. The assembly as recited in claim 2, wherein at least a portion of said skirting portion is made from a soft grippable material.

8. The assembly as recited in claim 1, including a handle portion.

9. The assembly as recited in claim 8, wherein said handle portion is integral to said body.

10. The assembly as recited in claim 1, wherein said body includes an engagement portion, said engagement portion including a lower engagement end that includes said threaded portion and an upper engagement end that receives said cap.

11. The assembly as recited in claim 10, wherein said cap includes an outer peripheral ring that engages the upper engagement end and an inner peripheral ring that engages an opening of said lower engagement end to provide a fluidic seal when said cap is engaged with said body in a closed position.

12. The assembly as recited in claim 1, wherein said cap is not integral to said body.

13. The assembly as recited in claim 1, wherein said cap is hingably attached to said body.

14. A method for manufacturing a replaceable cap assembly for use with at least one bottle, said bottle including a threaded neck, said method comprising the steps of:
providing a body having a threaded portion that can be releasably attached to the threaded neck of said at least one bottle; and
providing a releasable snap-fitting cap for selectively covering said threaded portion, thereby enabling the contents of a beverage container to be accessed for consumption.

15. A method as recited in claim 14, including the step of providing means for retaining said snap-fitting cap on said body when said cap is not covering said threaded portion.

16. A method as recited in claim 14, including the step of providing a handle portion in relation to said body to enable said assembly and an attached bottle to be lifted.
